(19) United States
(12) Patent Application Publication
(10) Pub. No.: US 2008/0043952 A1
(43) Pub. Date: Feb. 21, 2008

(54) METHOD AND APPARATUS FOR PROVIDING AND USING A TELEPHONE CALLING CARD

(76) Inventors: Jeffrey Citron, Holmdel, NJ (US); Louis Mamakos, Lawrenceville, NJ (US)

Correspondence Address: MOSER IP LAW GROUP, 2nd floor, 1040 Broad Street, Shrewsbury, NJ, 07702, US

(21) Appl. No.: 11/770,992

(22) Filed: Jun. 29, 2007

Related U.S. Application Data
(60) Provisional application No. 60/817,409, filed on Jun. 30, 2006.

(51) Int. Cl. H04M 15/00

(52) U.S. Cl. 379/114.15

(57) ABSTRACT

Method and apparatus for providing and using a telephone calling card are described. In one example, a planar body includes a memory system, a dual-tone multi-frequency (DTMF) generator, and a speaker. The memory system is configured to store identification data for allowing a user to place a telephone call. The DTMF generator is coupled to the memory system and is configured to generate password-protected DTMF tones to convey the identification data. The speaker is coupled to the DTMF generator and is configured to emit the DTMF tones. The DTMF tones may be played into a telephone for making a call using the telephone calling card apparatus. Since the identification data (e.g., account number and/or personal identification number) is played into the telephone and password-protected, rather than being manually entered by the user, the identification data is less susceptible to unauthorized disclosure and thus less susceptible to fraudulent use.

### CROSS-REFERENCE TO RELATED APPLICATIONS

This application claims priority to U.S. provisional application Ser. No. 60/817,409, filed Jun. 30, 2006, which is incorporated by reference herein in its entirety.

### BACKGROUND OF THE INVENTION

1. Field of the invention

The present invention relates generally to telephone systems and, more particularly, to a method and apparatus for providing and using a telephone calling card.

2. Description of the Related Art

The use of telephone calling cards is well known. For example, a customer may receive a telephone card that authorizes telephone call charges to be charged to the customer's account. Typically, the user has to dial a number associated with the calling card processing service and is prompted to dial-in an account number and a personal identification number (PIN) for authentication and authorization purposes. Once the authorization and authentication step is complete, the caller is prompted to dial the called party's telephone number and charges for the call are charged to the customer's account. These types of calling card are susceptible to fraud if the account number and the PIN are disclosed to unauthorized users. One well known fraud technique is to monitor a person making a call using a calling card. By monitoring and recording the numbers being dialed into the phone, a person can determine the numbers which need to be dialed to gain access to the account and thus can make unauthorized telephone calls using the account.

One technique for combating this type of fraud requires the use of a specialized phone having a magnetic card reader. The account and PIN information is embedded in a magnetic strip on the calling card. When a card holder wants to use the calling card, the card is inserted into the magnetic card reader and the account and PIN information can be read. This method of automatically reading the account and PIN information obviates the necessity of the user having to dial this information using the key pad. Therefore, the account and PIN information is not inadvertently disclosed to a third person monitoring the use of the phone by a user. A major disadvantage to this technique, however, is that this calling card can only be used with phones having the capability to read the magnetic strip.

Accordingly, there exists a need in the art for a method and apparatus for providing and using a telephone calling card that prevents fraud and does not require specialized telephone equipment to use.

### SUMMARY OF THE INVENTION

An aspect of the invention relates to a telephone calling card apparatus. A planar body includes a memory system, a dual-tone multi-frequency (DTMF) generator, and a speaker. The memory system is configured to store identification data for allowing a user to place a telephone call. The DTMF generator is coupled to the memory system and is configured to generate DTMF tones to convey the identification data. The speaker is coupled to the DTMF generator and is configured to emit the DTMF tones. The DTMF tones may be played into a telephone for making a call using the telephone calling card apparatus. Since the identification data (e.g., account number and/or personal identification number) is played into the telephone, rather than being manually entered by the user, the identification data is less susceptible to unauthorized disclosure and thus less susceptible to fraudulent use.

Another aspect of the invention relates to processing a telephone call. Dual-tone multi-frequency (DTMF) tones generated by a DTMF generator on a calling card are received from a first endpoint. The DTMF tones convey identification data associated with a user. The identification data is validated. A telephone number for a call is obtained from the user. The call is routed from the first endpoint to a second endpoint associated with the telephone number. In some embodiments, the first and second endpoints are coupled to the public switched telephone network (PSTN). The call is routed over a packet network. In this manner, a call between non-subscribers to voice-over-internet-protocol (VoIP) technology may be handled using VoIP technology.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a communication system in accordance with one or more aspects of the invention;

FIG. 2 is a flow diagram depicting an exemplary embodiment of a method of processing a telephone call in accordance with one or more aspects of the invention;

FIG. 3 is a block diagram depicting an exemplary embodiment of the secure calling card in accordance with one or more aspects of the invention;

FIG. 4 is a block diagram depicting another exemplary embodiment of a communication system in accordance with one or more aspects of the invention; and

FIG. 5 is a flow diagram depicting another exemplary embodiment of a method of processing a telephone call in accordance with one or more aspects of the invention.

### DETAILED DESCRIPTION

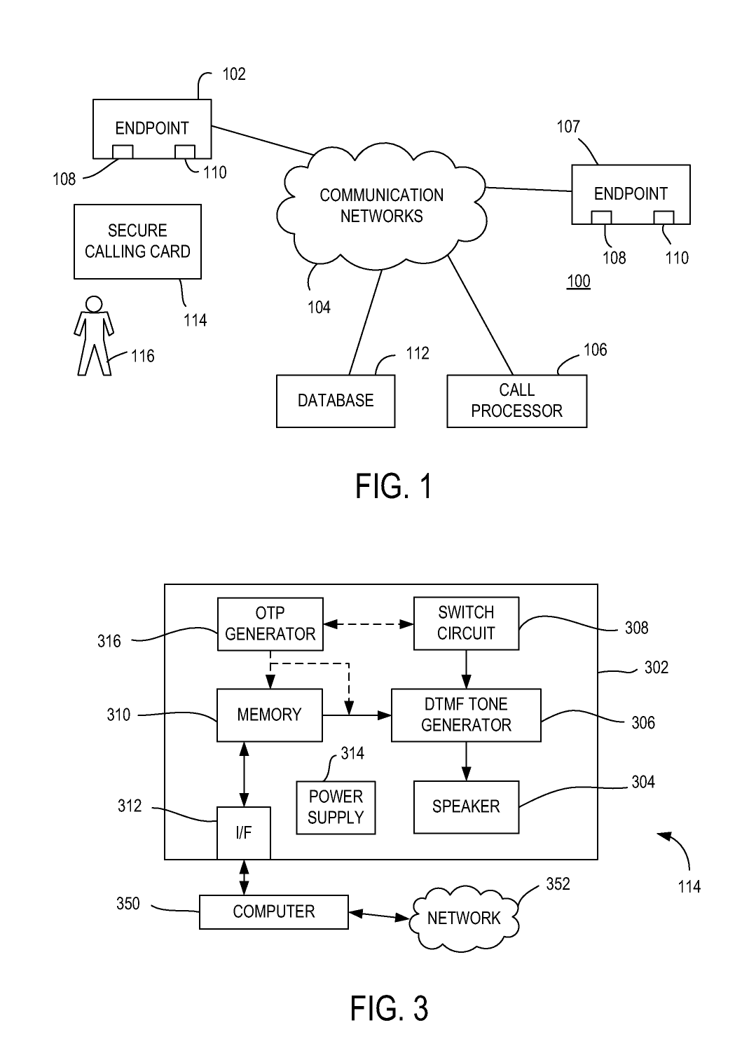

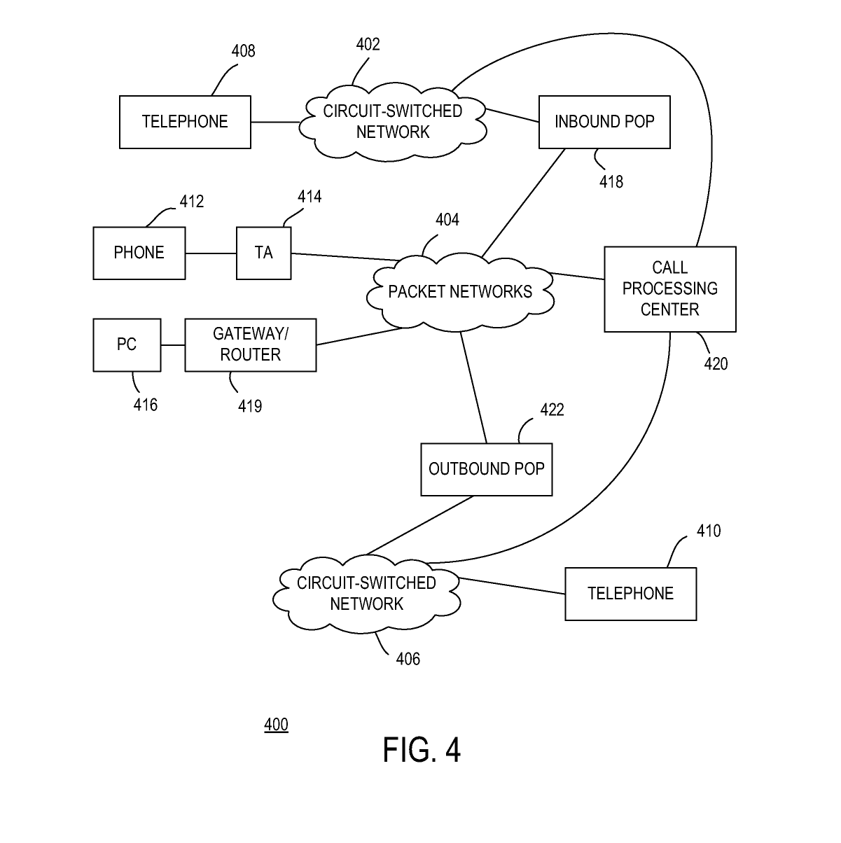

FIG. 1 is a block diagram depicting an exemplary embodiment of a communication system 100 in accordance with one or more aspects of the invention. The communication system 100 includes a first endpoint 102, one or more communication networks 104, a call processor 106, and a second endpoint 107. The communication networks 104 may include various types of circuit-switched and/or packet networks, which may comprise the public switched telephone network (PSTN), voice-over-internet-protocol (VoIP) networks, the Internet, and the like. A more detailed example of the communication networks 104 is described below with respect to FIG. 4. The endpoints 102 and 107 may include various types of devices capable of making and receiving telephone calls over the communication networks 104, including time division multiplexed (TDM) phone (i.e., a conventional telephone), an internet protocol (IP) phone, a computer, or the like. Among other well known components, the endpoints 102 and 107 include a microphone 108 for capturing sound and a speaker 110 for emitting sound.

The call processor 106 includes various devices and systems for implementing a call processing center. The call processor 106 is configured to perform one or more functions, including the processing of telephone calls made using telephone calling cards. The call processor 106 may be coupled to a database 112 that maintains data associated with calling card accounts. Such data may include account identifiers and/or personal identification number (PINs) associated with telephone calling cards. The telephone calling cards handled by the call processor 106 may be conventional calling cards, where users use the cards to make telephone calls that are then billed to the corresponding accounts. Other exemplary telephone calling cards include “pre-paid” calling cards. A pre-paid calling card is associated with an account that is pre-loaded with a block of minutes to be used. A customer purchases the pre-paid calling card for a particular fee. In essence, a user purchases a block of minutes to be used to make telephone calls. As the users make telephone calls, the balance is debited from the associated pre-paid calling cards for the amount of time spent for each call. Some pre-paid calling cards are disposed of when the balance in the account is depleted. Other pre-paid calling cards may be “re-charged” by purchasing additional minutes.

In some embodiments, a call is made from the first endpoint 102 to the second endpoint 107 using a secure telephone calling card (“secure calling card 114”). The secure calling card 114 obviates the need for a user 116 to dial or otherwise enter identification data, such as an account number and/or PIN number. Rather, the secure calling card 114 is configured to generate and play a sequence of dual-tone multi-frequency (DTMF) tones upon command of the user 116. The DTMF tones convey identification data to making telephone calls, such as an account number and/or PIN number. The user 116 positions the secure calling card 114 such that the DTMF tones are captured by the microphone 108 of the first endpoint 102. In this manner, the secure calling card 114 substantially reduces the risk that the identification data (e.g., account number and/or PIN) are illicitly obtained by third parties as the user 116 uses the card. Exemplary embodiments of the secure calling card 114 are described below.

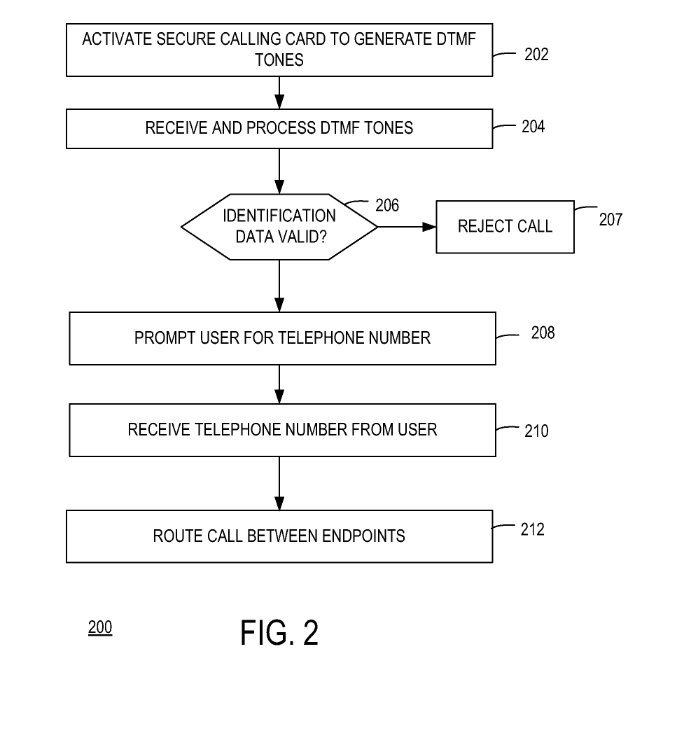

FIG. 2 is a flow diagram depicting an exemplary embodiment of a method 200 of processing a telephone call in accordance with one or more aspects of the invention. The method 200 may be understood with reference to the communication system 100 of FIG. 1. The method 200 begins at step 202, where the user 116 activates the secure calling card 114 to generate DTMF tones such that the DTMF tones are captured by the microphone 108 of the first endpoint 102. In some embodiments, the DTMF tones convey a telephone number of the call processor 106 (e.g., a toll-free telephone number associated with a brand of calling cards). In other embodiments, the user 116 first dials the telephone number of the call processor 106 before playing the DTMF tones into the first endpoint 102. In any case, the DTMF tones also convey identification data that allows the user 116 to make a telephone call using the secure calling card 114, such as an account number, a PIN, or both.

At step 204, the call processor 106 receives and processes the DTMF tones to validate the identification data. At step 206, a determination is made whether the identification data is valid. For example, a determination is made whether an account number is valid and exists, whether a PIN number associated with the account is valid, whether the account can be used to make a call (e.g., whether there are minutes pre-paid for on the account), or the like. If the identification data is valid, the method 200 proceeds to step 208. Otherwise, the method 200 proceeds to step 207, where the use of the secure calling card 114 by the user 116 is rejected.

At step 208, the call processor 106 prompts the user 116 to enter a telephone number, for example, the telephone number of the second endpoint 107. At step 210, the call processor 106 receives a telephone number from the user 116 (e.g., the user enters the telephone number using the first endpoint 102 in response to the prompt). At step 212, the call processor 106 routes a call from the first endpoint 102 to the second endpoint 107. For example, the call processor 106 causes the second endpoint 107 to indicate an incoming call. If the incoming call is answered at the second endpoint 107, the call processor 106 facilitates a connection between the first endpoint 102 and the second endpoint 107 through the communication networks 104.

FIG. 3 is a block diagram depicting an exemplary embodiment of the secure calling card 114 in accordance with one or more aspects of the invention. The secure calling card 114 includes a generally planar body 302. The body 302 may be fashioned from plastic, metal, or like-type materials, or a combination of such materials. The body 302 includes a speaker 304, a DTMF tone generator 306, switch circuitry 308, and a memory system 310. The memory system 310 is configured to store identification data that allows a user to make telephone calls. As described above, the identification data may include an account number, a PIN, or both. The identification data may further include a telephone number of a call processing center. In some embodiments, the memory system 310 comprises a non-volatile memory system, such as a programmable read-only memory (PROM), an erasable PROM (EPROM), an electronically erasable PROM (EEPROM), FLASH memory, or the like. In some embodiments, the memory system 310 may include a removable component, such as a removable FLASH memory card.

The memory system 310 is accessible by the DTMF tone generator 306. The DTMF tone generator 306 is configured to read the identification data from the memory system 310 and generate DTMF tones to convey the identification data. The DTMF tone generator 306 drives the speaker 304 to emit the generated DTMF tones. The speaker 304 allows the DTMF tones to be played into a microphone of an endpoint device. The DTMF tone generator 306 is controllable via the switch circuitry 308. The switch circuitry 308 may include a button or like type activation device on the body 302 of the secure calling card 114. When the switch circuitry 308 is activated by a user, the DTMF tone generator 306 is commanded to generate the DTMF tones in accordance with the identification data stored in the memory system 310.

In an alternate embodiment of the invention, the secure calling card 114 further includes a password generator 316 (OTP generator). The password generator 316 is connected to the DTMF tone generator 306 in any manner necessary and known to those skilled in the art to achieve the desired affect as described below. In one embodiment, the password generator 316 is connected between the switch circuitry 308 and the DTMF tone generator 306 so as to generate a one-time password each time the switch circuitry 308 is activated by a user. The one-time password is, for example, an irreversible transformation value that is representative of DTMF tones when activated via the switch circuitry 308. Alternately, the password generator 316 can be connected between the switch circuitry 308 and the memory system 310 so that the one-time password is temporarily stored in memory system 310 for instant playback or confirmation with for example, the call processor 106 or similar communication system component. With this feature, the identification data stored in the memory system 310 is encoded differently at each instance of switch circuitry 308 being activated. This further ensures security of the identification data and reduces the likelihood of fraud. In order to “understand” that the one-time password and corresponding tones are identifying a proper user of the system, the call processor 106 or other similar communication system component operates in accordance with a security protocol or process that employs the irreversible transformation. In one embodiment of the invention, the one-time password is HMAC-based One Time Password (HOTP) as seen and described in IETF RFC 4226 herein incorporated in its entirety by reference. Other protocols are possible as known to those skilled in the art including but not limited to S/Key as described in IETF RFC 1760. Note that in the embodiment depicted in FIG. 3, the password generator 316 is represented as a hardware module interconnected to other modules of the secure calling card 114. Alternately, the password generator 316 is represented as a software module containing the necessary code or computer-language instructions to execute the security protocol necessary to provide the one-time password. For example, the password generator 316 may be part of the memory system 310 that is accessed by the DTMF tone generator 306 when the secure calling card 114 is activated.

In some embodiments, the body 302 further includes a communication interface (I/F) 312. The communication interface 312 is coupled to the memory system 310. The communication interface 312 may be used to store identification data to the memory system 310, or update identification data stored in the memory system 310. The communication interface 312 may comprise any type of communication circuitry known in the art, including any wired interface (e.g., universal serial bus (USB)), wireless interface, or the like.

The secure calling card 114 may be associated with a traditional account or a pre-paid account. The memory system 310 may be updated with new identification data over time. For example, in case of a pre-paid card, the memory system 310 may be updated in response to purchase of another block of minutes (e.g., the account number and/or PIN may change for the newly purchased minutes). The memory system 310 may be updated using the communication interface 312. For example, the communication interface 312 may be coupled to a computer 350 coupled to a network 352, such as the Internet. In this manner, new or updated identification data may be downloaded from the network 352 through the computer 350 to the secure calling card 114 for storage in the memory system 310. If the memory system 310 includes a removable component, such as a removable FLASH memory chip, the identification data may be updated by inserting a new removable component into the memory system 310. Alternatively, the removable component may be removed, updated, and re-inserted into the memory system 310. Those skilled in the art will appreciate that there are a myriad of possible mechanisms for updating the identification data in the memory system 310.

For purposes of clarity by example, the speaker 304, the DTMF tone generator 306, the switch circuitry 308, the memory system 310, and the communication interface 312 are shown as separate functional elements. Those skilled in the art will appreciate that one or more of such components may be combined and implemented as a single device, such as an integrated circuit (IC). In any case, the electrical components on the secure calling card 114 are coupled to a power source 314 in the body 302. The power source 314 may comprise any type of power source known in the art, including a battery, solar power cells, or the like.

FIG. 4 is a block diagram depicting another exemplary embodiment of a communication system 400 in accordance with one or more aspects of the invention. The communication system 400 shows a more detailed embodiment of the communication system 100 of FIG. 1. The communication system 400 includes a circuit-switched network 402, one or more packet networks 404, and a circuit-switched network 406. The circuit-switched networks 402 and 406 may be part of the same network, generally referred to as the Public Switched Telephone Network (PSTN). As is well known in the art, the PSTN comprises a collection of local exchange carriers (LECs) and inter-exchange carriers (IXC). The packet networks 404 may comprise various interconnected internet protocol (IP) networks operated by various entities. At least a portion of the packet networks 404 may be generally referred to as the Internet.

In the present example, a first telephone 408 is coupled to the circuit-switched network 402, and a second telephone 410 is coupled to the circuit-switched network 406. The telephones 408 and 410 comprise traditional telephones coupled to the PSTN and may be referred to as PSTN telephones. The packet networks 404 are also used to carry telephone calls, such service generally referred to as voice-over-internet-protocol (VoIP). For example, VoIP technology allows users to place telephone calls through the Internet, rather than using the PSTN. In the present example, a third telephone 412 is coupled to a terminal adapter (TA) 414, which is in turn coupled to the packet networks 404. One of the functions of the TA 414 is to convert the voice signals to digital data packets for transmission over the packet networks 404. Some phones have built-in terminal adapters and are typically referred to as IP phones.

Also in the present example, a personal computer (PC) 416 is coupled to a router 419, which is in turn coupled to the packet networks 404. As a PC typically includes a microphone and speaker, the PC 416 can also be used as a telephone (e.g., using a “softphone” application) thereby operating similarly to the third telephone 412 and TA 414. The PC 416 performs the function of the TA to covert voice signals to digital data packets for transmission over the packet networks 404. Although telephones and PCs are shown by example, those skilled in the art will appreciate that other types of devices may be used to implement VoIP telephones, such as notebook computers, personal digital assistants (PDAs), and the like.

In some cases, a user of a PSTN telephone will call a user of a VoIP telephone, such as a call between the first telephone 408 and the third telephone 412 (PSTN-to-VoIP call flow). In such cases, a user of the first telephone 408 dials the phone number assigned to user of the third telephone 412. The circuit-switched network 402 recognizes the telephone number as a number associated with a VoIP service provider and transmits the call to an inbound point of presence (POP) or regional data center (RDC) (“inbound POP/RDC 418”). The inbound POP/RDC 418 provides an interface between the circuit-switched network 402 and the packet networks 404. The inbound POP/RDC 418 provides the call to a call processing center 420 of the VoIP service provider via the packet networks 404. The call processing center 420 obtains the IP address of the TA 414 associated with the telephone. The call processing center 420 then signals the TA 414 of the incoming call. The signaling between the inbound POP/RDC 418 and the call processing center 420, and between the call processing center 420 and the TA 414, may be performed using various signaling protocols, such as the Session Initiation Protocol (SIP) as identified in the Internet Engineering Task Force (IETF) RFC 3261 (herein incorporated by reference) or the like. If the call is answered at the third telephone 412, a voice stream is established between the TA 414 and the inbound POP/RDC 418 over the packet networks 404, such as a real-time transport protocol (RTP) stream or the like. The inbound POP/RDC 418 converts the voice stream for transmission over the circuit-switched network 402 to the first telephone 408. At the end of the call, the inbound POP/RDC 418 and the TA 414 signal the call processing center 420 that the call has ended. As a result, the call processing center 420 can determine the appropriate billing information. The above-described call flow is merely exemplary and various details related thereto have been omitted for clarity.

In other cases, a user of a VoIP telephone will call a user of a PSTN telephone, such as a call between the third telephone 412 and the second telephone 410 (VoIP-to-PSTN call flow). In such cases, a user of the third telephone 412 dials the phone number assigned to the user of the second telephone 410. The call processing center 420 recognizes the telephone number as being a standard PSTN telephone number and provides the call to an outbound POP or RDC (“outbound POP/RDC 422”) via the packet networks 404. The outbound POP/RDC 422 provides an interface between the packet networks 404 and the circuit-switched network 406. The outbound POP/RDC 422 coverts the IP data to time division multiplexed (TDM) format, which is handed off to the circuit-switched network 406. The circuit-switched network 406 then signals the second telephone 410 of the incoming call in a conventional manner. The signaling between the outbound POP/RDC 422 and the call processing center 420, and between the call processing center 420 and the TA 414, may be performed using various signaling protocols, such as SIP or the like. If the call is answered at the second telephone 410, a voice stream is established between the TA 414 and the outbound POP/RDC 422 over the packet networks 404, such as an RTP stream or the like. At the end of the call, the outbound POP/RDC 422 and the TA 414 signal the call processing center 420 that the call has ended. As a result, the call processing center 420 can determine the appropriate billing information. The above-described call flow is merely exemplary and various details related thereto have been omitted for clarity.

In the above-described call flows, one of the users has subscribed to VoIP technology (e.g., the user of the third telephone 412). Users who have not subscribed to VoIP technology have not previously been given the option of using VoIP technology for calls placed to other non-subscribing users. For example, a call between the telephone 402 and the second telephone 410 is typically facilitated using only the PSTN (circuit switched networks 404 and 406). In some embodiments of the invention, users of PSTN telephones can selectively use VoIP technology, even when the users are non-subscribers to VoIP technology and are calling other non-subscribers of VoIP technology (e.g., a call between PSTN phones). This may be done using the secure calling card 114.

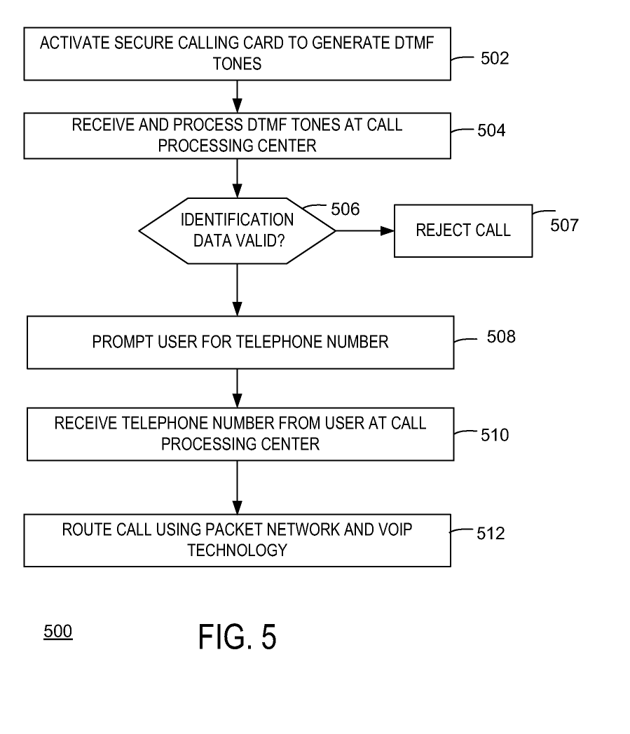

FIG. 5 is a flow diagram depicting an exemplary embodiment of a method 500 of processing a telephone call in accordance with one or more aspects of the invention. The method 500 may be understood with reference to the communication system 400 of FIG. 4. In particular, a user of a PSTN telephone (e.g., the telephone 402) obtains the secure calling card 114 provided by a VoIP service provider. Assume the VoIP service provider that provides the secure calling card 114 also operates the inbound and outbound POP/RDCs 418 and 422, as well as the call processing center 420. The call processing center 420 is coupled to the PSTN (e.g., the circuit-switched network 404 and/or the circuit switched network 406). Thus, in some embodiments, the call processing center 420 provides a similar function as the POP/RDC, i.e., interfacing between the packet networks 404 and the PSTN.

The method 500 begins at step 502, where the user activates the secure calling card 114 to generate DTMF tones such that the DTMF tones are captured by a PSTN telephone (e.g., the telephone 402). In some embodiments, the DTMF tones convey a telephone number of the call processing center 420 (e.g., a toll-free telephone number associated with a brand of calling cards). In other embodiments, the user first dials the telephone number of the call processing center 420 before playing the DTMF tones into the telephone 402. In any case, the DTMF tones also convey identification data that allows the user to make a telephone call using the secure calling card 114, such as an account number, a PIN, or both. In one embodiment, the DTMF tones are repeated at every instance of secure calling card 114 activation. Alternately, the DTMF tones are randomly generated at every instance of secure calling card 114 activation for further fraud prevention.

At step 504, the call processing center 420 receives and processes the DTMF tones to validate the identification data. At step 506, a determination is made whether the identification data is valid. For example, a determination is made whether an account number is valid and exists, whether a PIN number associated with the account is valid, whether the account can be used to make a call (e.g., whether there are minutes pre-paid for on the account), or the like. If the identification data is valid, the method 500 proceeds to step 508. Otherwise, the method 500 proceeds to step 507, where the use of the secure calling card 114 by the user is rejected.

At step 508, the call processing center 420 prompts the user to enter a telephone number, for example, the telephone number of a PSTN telephone (e.g., the second telephone 410). At step 510, the call processing center 420 receives a telephone number from the user (e.g., the user enters the telephone number using the telephone 402 in response to the prompt). At step 512, the call processing center 420 routes a call from the telephone 402 to the called telephone using the packet networks 404. The call processing center 420 receives and packetizes the voice signals from the telephone 402 for transmission over the packet networks 404. If the called telephone is a VoIP telephone (e.g., the third telephone 412), the call processing center 420 routes the call to the TA 414 through the packet networks 404, as described above in the PSTN-to-VoIP call flow. If the called telephone is a PSTN telephone (e.g., the second telephone 410), the call processing center 420 routes the call to a POP/RDC (e.g., the outbound POP/RDC 422) through the packet networks 404, as described above in the VoIP-to-PSTN call flow. In this manner, a call between two PSTN telephones may be facilitated using VoIP technology.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A telephone calling card apparatus, comprising:
a planar card body having mounted thereon:
a memory system configured to store identification data for allowing a user to place a telephone call;
a dual-tone multi-frequency (DTMF) generator, coupled to the memory system, configured to generate DTMF tones to convey the identification data; and
a speaker, coupled to the DTMF generator, for emitting the DTMF tones.

2. The apparatus of claim 1, further comprising a password generator coupled to the DTMF generator.

3. The apparatus of claim 1, wherein the identification data includes at least one of: an account identifier or a personal identification number (PIN).

4. The apparatus of claim 3, wherein the identification data further includes a telephone number of a call processing service.

5. The apparatus of claim 4, wherein the call processing service comprises a voice-over-internet-protocol (VoIP) service provider.

6. The apparatus of claim 1, wherein the planar card body further includes:
switch circuitry, coupled to the DTMF generator, configured to control the DTMF generator to generate the DTMF tones.

7. The apparatus of claim 1, wherein the planar card body further includes:
a communication interface, coupled to the memory system, configured to receive the identification data or updates to the identification data for storage in the memory system.

8. A method of processing a telephone call, comprising:
receiving, from a first endpoint, dual-tone multi-frequency (DTMF) tones generated by a DTMF generator on a calling card, the DTMF tones conveying identification data associated with a user;
validating the identification data;
obtaining a telephone number for a call from the user; and
routing the call from the first endpoint to a second endpoint associated with the telephone number.

9. The method of claim 8, wherein the identification data includes at least one of: an account identifier or a personal identification number (PIN).

10. The method of claim 8, wherein the DTMF tones are received at a call processing center of a voice-over-internet-protocol (VoIP) service provider.

11. The method of claim 10, wherein the first and second endpoints are each coupled to a public switched telephone network (PSTN), and wherein the call is routed over a packet network.

12. The method of claim 10, wherein one of the first and second endpoints is coupled to a public switched telephone network (PSTN) and another of the first and second endpoints is coupled to a packet network, and wherein the call is routed over a packet network.

13. The method of claim 10 wherein the received DTMF tones are randomized at each instance of conveying the identification data.

14. A communication system, comprising:
a first endpoint;
a second endpoint;
a calling card configured to generate dual-tone multi-frequency (DTMF) tones and to play the DTMF tones into the first endpoint, the DTMF tones conveying identification data associated with a user;
a call processing center configured to validate the identification data, obtain a telephone number associated with the second endpoint from the user, and route a call from the first endpoint to the second endpoint.

15. The system of claim 14, wherein the first endpoint and the second endpoint are each coupled to a public switched telephone network (PSTN).

16. The system of claim 14, wherein one of the first and second endpoints is coupled to a public switched telephone network (PSTN) and another of the first and second endpoints is coupled to a packet network.

17. The system of claim 13, wherein the calling card comprises:
a planar card body having mounted thereon:
a memory system configured to store the identification data;
a DTMF generator, coupled to the memory system, configured to generate the DTMF tones to convey the identification data; and
a speaker, coupled to the DTMF generator, for emitting the DTMF tones.

18. The system of claim 17, wherein the calling card further comprising a password generator coupled to the DTMF generator.

19. The system of claim 17, wherein the planar card body further includes:
switch circuitry, coupled to the DTMF generator, configured to control the DTMF generator to generate the DTMF tones.

20. The system of claim 3, wherein the identification data includes at least one of: an account identifier or a personal identification number (PIN).
